(19) United States
(12) Patent Application Publication
(10) Pub. No.: US 2004/0117276 A1
(43) Pub. Date: Jun. 17, 2004

(54) Online list generation process and method

(76) Inventor: Edward Kettler III, Plano, TX (US)

Correspondence Address: JOHN F. HAYDEN, FISH & RICHARDSON P.C., SUITE 1100, 1425 K STREET, N.W., WASHINGTON, DC, 20005, US

(21) Appl. No.: 10/321,291

(22) Filed: Dec. 17, 2002

(51) Int. Cl. G06F 17/60

(52) U.S. Cl. 705/29

(57) ABSTRACT

An online list generation process includes a product database having a product list that itemizes products offered for sale by a merchant. A user interface allows a potential customer to access the product database and retrieve at least a portion of the product list. A user selection process enables the potential customer to select one or more of the individual products itemized in the retrieved portion of the product list. A shopping list is generated that itemizes the individual products that the potential customer intends to pick up from the merchant's place of business.

### TECHNICAL FIELD

This description relates to online shopping list generation.

### BACKGROUND

Traveling to a merchant's store and shopping for merchandise often results in the store not selling the brand names or varieties of merchandise that a customer wants to purchase. Further, when products are out of stock, the potential customer has to make an in-store decision concerning substitute products.

Online shopping, on the other hand, provides the potential customer with the convenience of being able to leisurely review the products that the online merchant offers for sale. Additionally, in the event that a product is out of stock, the consumer can evaluate the other products offered by the online merchant to determine if any of them are suitable as a substitute.

### SUMMARY

In one general aspect, a shopping list is generated online using a product database having a product list that itemizes the products offered for sale by a merchant. A user interface allows a potential customer to access the product database and retrieve at least a portion of the product list. The potential customer then is enabled to select one or more of the individual products itemized in the retrieved portion of the product list for pickup from the merchant's place of business. A shopping list is generated that itemizes the selected products.

Implementations may include one or more of the following features. For example, an inventory database may itemize the products that are currently in stock at the merchant's place of business. The inventory database is accessed to determine if the individual products itemized in the shopping list are in stock at the merchant's place of business. When a product on the shopping list is out of stock, the potential customer may be offered a substitute product.

If the merchant has multiple places of business, the inventory database may be configured to itemize the products that are currently in stock at each of the merchant's places of business. Additionally, the potential customer may select the place of business at which the potential customer intends to shop. When a product on the shopping list is out of stock at the place of business at which the potential customer intends to shop, the potential customer may be informed that the out-of-stock product is available at an alternate place of business.

The product database includes product location information for one or more of the products offered for sale by the merchant, such that the product location information specifies the physical location of the product within the merchant's place of business. The individual products itemized in the shopping list may be sorted in accordance with their physical location within the merchant's place of business. A floor space map of the merchant's place of business may be generated to assist the potential customer in locating the products itemized in the shopping list.

The shopping list may be transferred to the merchant's place of business in association with a customer identifier for associating the shopping list with the potential customer. The individual products itemized in the shopping list may be retrieved so that they can be easily picked up by the potential customer.

An automatic determination may be made as to whether any of the individual products itemized in the shopping list are being discounted.

The product database may include product specification information, product review information, or complimentary product information, for one or more of the products offered for sale by the merchant.

The above-described processes may be implemented as a method or a sequence of instructions executed by a processor.

Using the processes, the benefits of online and traditional shopping can be combined, while the inconveniences of both minimized. The potential customer can determine ahead of time what products the merchants sells and whether or not they are in stock. Further, the potential customer can make informed decisions concerning product substitutions. By picking up the products from the merchant, the potential customer can save time and shipping costs. By providing the potential customer with product location information, the potential customer can quickly and efficiently move throughout the store. Further, by offering the potential customer complimentary and substitute products, cross selling can be enhanced.

Other features will be apparent from the following description, including the drawings, and the claims.

### DESCRIPTION OF DRAWINGS

FIG. 1 is a block diagram of a computer network that may be used to implement an online list generation process.

FIG. 2 is a flowchart showing one implementation of the online list generation process.

FIG. 3 is a block diagram of an online list generation method.

### DETAILED DESCRIPTION

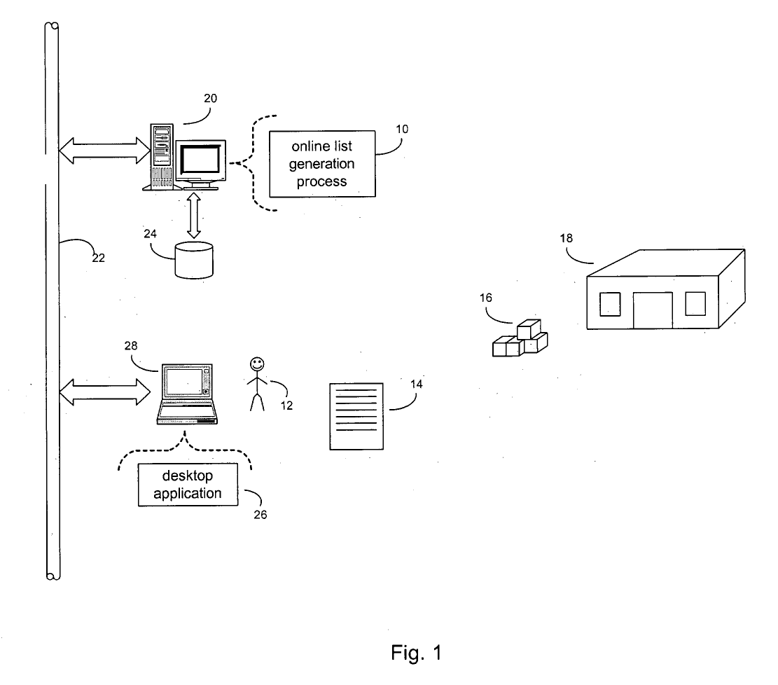

Referring to FIG. 1, an online list generation process 10 allows a potential customer 12 to quickly generate a shopping list 14 that itemizes the products 16 that the potential customer 12 intends to purchase at a merchant's store or place of business 18. Online list generation process 10 resides on and is executed by a computer 20 that is connected to a network 22 (e.g., the Internet, an intranet, a local area network, or some other form of network). The instruction sets and subroutines of online list generation process 10 are typically stored on a storage device 24 connected to computer 20. Storage device 24 may be, for example, a hard disk drive, a tape drive, an optical drive, a RAID array, a random access memory (RAM), or a read-only memory (ROM). Potential customer 12 typically accesses and uses online list generation process 10 through a desktop application 26 (e.g., Microsoft Internet Explorer™, Netscape Navigator™, or a specialized desktop interface) running on a computer 28 that is also connected to the network 22.

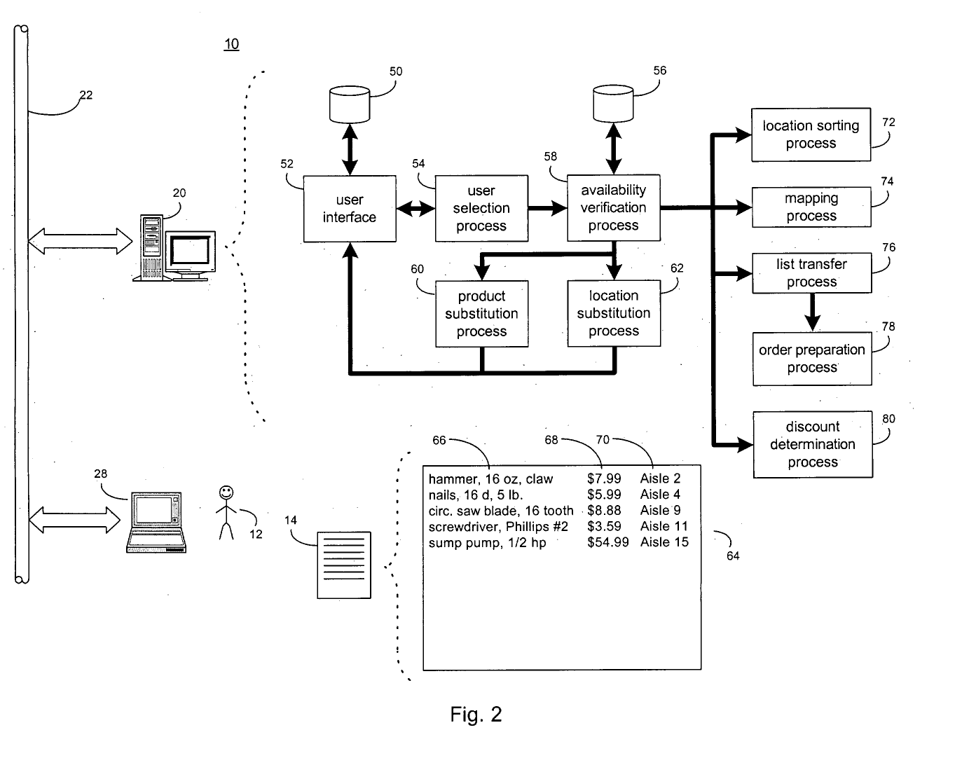

Referring also to FIG. 2, online list generation process 10 includes a product database 50. Examples of product database 50 are Oracle™, Access™ and SQL™ databases. Product database 50 includes information concerning the various products that are sold by the merchant. Examples of the types of information included in product database 50 are the names and identifiers (e.g., SKU “Stock-Keeping-Unit” numbers and product numbers) of the products sold by the merchant. Opinions and reviews concerning these products, as well as detailed descriptions and in-store location information may also be included in product database 50. Additionally, substitute (i.e. equivalent) and complimentary products may also be specified for some of the products sold by the merchant.

A user interface 52 allows potential customer 12 to access (using computer 28) the online list generation process 10, so that the potential customer 12 can retrieve product information from product database 50. Typically, prior to accessing online list generation process 10, potential customer 12 would have to “log in” to the website through which the potential customer is accessing process 10. This may require potential customer 12 to register with the website so that a username and password are established for potential customer 12. When accessing online list generation process 10, potential customer 12 searches for products to purchase and pick up at the merchant's store 18. This searching can occur is various ways. For example, potential customer 12 may enter various search terms or keywords into a search engine (not shown), such that the online list generation process 10 provides potential customer 12 with a list of those products having descriptions including those search terms or keywords. Alternatively, potential customer 12 may penetrate down through a multi-level menu structure (not shown) to reach desired products. For example, if the merchant was a department store and potential customer 12 was interested in buying a hammer using online list generation process 10, potential customer 12 would use the menu to select, for example, “hardware”, “tools”, “hand tools”, and “hammers”.

When potential customer 12 completes the searching (either with keywords or menus), a list is generated that itemizes a portion of the products offered for sale by the merchant (i.e., products matching the search terms entered by the potential customer 12 or products within the portion of the menu selected by the potential customer 12). Continuing with the above-stated example, if potential customer 12 was looking for hammers, the list generated may appears as follows:

| Description | Unit Cost |
|---|---|
| hammer, 16 ounce, claw | $7.99 |
| hammer, 20 ounce, ball peen | $8.49 |
| hammer, 32 ounce, sledge | $9.99 |
| hammer, 48 ounce, sledge | $13.99 |

Upon reviewing this list, if potential customer 12 is interested in purchasing any of these products, potential customer 12 can select the products to be purchased. As stated above, product database 50 may include detailed descriptions, opinions, and reviews of the products offered for sale by the merchant, which may be used by potential customer 12 to decide whether to purchase a product.

The selection of the product(s) may be made is several ways, depending on how the system is configured by the system's administrator (not shown). For example, potential customer 12 may “click” on (using a mouse or other pointing device) a product to be purchased. Alternatively, the above-described list may include a check box next to each itemized product, such that the potential customer 12 can select the products to be purchased by placing checks in the appropriate check boxes.

Typically, when potential customer 12 initially selects a product, product database 50 is accessed to determine if any complimentary products are available. If complimentary products are available, user interface 52 informs potential customer 12 that these complimentary products are available for purchase. For example, if the potential customer was interested in purchasing paint brushes, complimentary products offered for purchase to potential customer 12 would be, for example, drop cloths, paint rollers, and turpentine.

A user selection process 54 monitors the selections made by potential customer 12 and adds the selected products to a shopping list 14 generated for potential customer 12. This shopping list 14, which indicates the products that potential customer 12 intends to pick up at the merchant's store 18, can be edited by user selection process 54 to remove items that the potential customer 12 subsequently decides not to purchase.

An inventory database 56 includes information concerning the products currently available (i.e., in stock, as opposed to those offered-for-sale) at the merchant's store 18. Examples of inventory database 56 are Oracle™, Access™, and SQL™ databases. Once potential customer 12 selects a product to be added to the shopping list 14, an availability verification process 58 accesses inventory database 56 to determine if that product is available at the merchant's store 18. If the merchant has multiple locations, potential customer 12 needs to specify at which of the merchant's stores (i.e., locations) the order is to be picked up.

In the event that a product included on shopping list 14 is not currently available in any of the merchant's stores (e.g., store 18), a product substitution process 60 determines if a suitable substitute product is available. For example, if potential customer 12 was looking for a sixteen ounce claw hammer with a hickory handle (which is out-of-stock), but a sixteen ounce claw hammer with a fiberglass handle is available, product substitution process 60 informs potential customer 12, through user interface 52, that this substitute product is available. If this substitute product is acceptable to the potential customer 12, the potential customer 12 can append the shopping list 14 to include the substitute product.

Additionally, if a product included on shopping list 14 is not available in the location at which the potential customer 12 intends to shop, but is available at a different location, a location substitution process 62 informs potential customer 12, through user interface 52, that the desired product is available at one of the merchant's other locations. Upon determining that the desired product is available at one of the merchant's other locations, location substitution process 62 may check to see if all of the other products (i.e., the products that are available at the desired location) are available at the alternate location. If so, location substitution process 62 notifies potential customer 12 that all of the products itemized in shopping list 14 are available at the alternate location, thus informing potential customer 12 that they can go to single location (i.e., the alternate location) and purchase all of the products on shopping list 14.

Product substitution process 0.60 and location substitution process 62 may work concurrently. In particular, if a product is determined to be out-of-stock, a substitute product is available at the location at which the potential customer intends to shop, and the exact product is available at different locations, the potential customer may be presented with both options and allowed to choose which, if any, are acceptable.

As stated above, product database 50 typically includes product location information that specifies the location (within store 18) of each product on shopping list 14. Typically, this location specifies the aisle or department in which the product is located. However, the locations can be as precise or as general as desired.

When generated, shopping list 14 includes one or more line items 64, each of which includes various pieces of information concerning the product selected, such as a product description 66, the product's selling price 68, and the product's location 70 within the merchant's store. This shopping list 14 can now be printed on a local printer accessible by computer 28 and brought with the customer to the merchant's store 18. Alternatively, shopping list 14 may be downloaded into a handheld “data-enabled” device (not shown), such as, for example, a laptop computer, a Pocket PC™, a personal digital assistant, a cell phone, or a wristwatch. This device can then be brought to store 18 by potential customer 12. Additionally, shopping list 14 may be uploaded to the merchant's store 18.

A location sorting process 72 allows potential customer 12 to sort the items in shopping list 14 in accordance with their locations throughout the merchant's store 18, and thereby enables potential customer 12 to shop more efficiently. Further, a mapping process 74 provides potential customer 12 with a floor space map (not shown) that indicates the location of the various aisles and departments throughout the store at which the potential customer 12 intends to shop. This mapping information (i.e., the floor plan of each of the merchant's store) may be stored within product database 52, inventory database 56, or on some other storage device (not shown). For added convenience, this floor space map may be overlaid with indicia that visually indicate the position of the products of shopping list 14 within store 18. For example, shopping list 14 includes five products: (a) hammer, 16 oz, claw; (b) nails, 16 d, 5 lb.; (c) circ. saw blade, 16 tooth; (d) screwdriver, phillips #2; and (e) sump pump ½ hp. Accordingly, the floor space map generated by mapping process 74 may include a symbol “a” positioned within aisle two to indicate the location of the sixteen ounce claw hammer; a symbol “b” positioned within aisle 4 to indicate the location of the five pounds of 16d nails; and so forth. This floor space map can also be printed out or downloaded to a handheld “data-enabled” device. As an alternative for or in addition to the floor space map, potential customer 12 may be provided with written directions concerning the location of the products within the merchant's place of business 18, thus providing the potential customer 12 with an efficient navigation path through the merchant's place of business.

A list transfer process, 76 allows potential customer 12 to electronically transfer (i.e., upload) shopping list 14 to the merchant's store 18. Shopping list 14, when transferred, includes a customer identifier that identifies potential customer 12 as the owner of the shopping list. The electronic transfer of the shopping list 14 can be accomplished by, for example, transferring shopping list 14 to the merchant as an email attachment.

Once shopping list 14 is transferred to the merchant, an order preparation process 78 notifies the merchant that the potential customer 12 intends to come to the merchant's store 18 and pick up the items included on shopping list 14. Employees of the merchant then can pull the products itemized on shopping list 14 and prepare the order for pick up by potential customer 12. Therefore, the order itemized in shopping list 14 can be prepared and readied for pickup while the potential customer 12 is traveling to the merchant's store 18.

A discount determination process 80 determines whether the potential customer 12 is entitled to any store-offered discounts or customer loyalty discounts. These discounts, for example, may include weekly specials, unannounced specials, volume discounts, membership discounts, group affiliation discounts (e.g., 4H club member, government employee, or veteran), and senior citizen discounts. When a potential customer 12 configures an online profile for process 10, the potential customer 12 is typically able to specify the types of discounts to which the customer expects to be entitled. The merchant may require that the potential customer prove the entitlement to this discount prior to the discount taking effect. For example, if potential customer 12 is initially establishing a profile with the merchant and enters a birth year of 1927, the potential customer would be entitled to a senior citizen discount. However, the first time that potential customer 12 picks up a merchandise order from the merchant's place of business 18, potential customer 12 may be required to show a driver's license to prove the customer's age.

If potential customer 12 is printing out shopping list 14 and bringing it to store 18, these discounts can be in the form of a printable coupon. Alternatively, if the shopping list 14 is electronically transferred to the merchant for order preparation, the discount(s) can be automatically applied to the total cost of the order when the order is picked up by potential customer 12.

If the potential customer 12 uses a handheld device to bring an electronic copy of shopping list 14 to store 18, upon arriving at store 18, potential customer 12 may use the handheld device to inform the merchant that the potential customer 12 has arrived at the store 18. This can be accomplished by using docking stations or cradles for the types of handheld, data-enabled devices supported by the merchant. Alternatively, a wireless communications protocol (such as Bluetooth or IR transmission) can be used to transmit the shopping list 14 and/or any confidential identification or account information to the merchant. Therefore, if the potential customer 12 had previously established billing terms (e.g., a credit card number on record) with the merchant, an order that was previously pulled and readied for pick up by the merchant may be purchased by simply having the potential customer 12 log into the merchant's computer system at store 18 (using, for example, a docking station, a cradle, Bluetooth, or IR).

Additionally, when potential customer 14 connects the handheld device to the merchant's computer system, shopping list 14 may be updated to verify that the products itemized in the shopping list are still in stock. If any of the itemized products are out of stock, process 10 may offer potential customer 12 substitute products that are currently available. In the event that the potential customer accepts these products, the product location information for these substitute product may be provided to potential customer 12. Potential customer 12 may then reprint the updated shopping list 14 and floor space map. Alternatively, potential customer 12 may provide updated shopping list 14 to the merchant so that the order can be pulled while the potential customer waits.

The merchant may place numerous wireless transceivers throughout the store 18 to allow the handheld device of the potential customer 12 to interface with the merchant's computer system while potential customer 12 shops in store 18. By monitoring the individual transceivers with which the potential customer's handheld device communicates, the potential customer's position within the store can be monitored. This enables the merchant to collect data concerning the patterns that potential customers follow while moving through the store 18. Additionally, as a communication link is established, the merchant can broadcast advertisements to potential customers while they shop. Further, the potential customer can be provided with real-time directions (similar to those provided by a global positioning system) to the products on the potential customer's shopping list 14.

While the manner in which the potential customer searches for products is described above as including either menus or a keyword search, the customer can search for products in other ways, such as by price range, by manufacturer, and by age group.

While process 10 is described above as being used for a merchant's single place of business, process 10 may be used for multiple businesses located within a common area. For example, the merchant may be a shopping mall and process 10 may allow a potential customer to review online the products offered by the various stores within the mall. Potential customer 12 could then select products from the various stores and process 10 would generate a shopping list including merchandise from these stores. Additionally, any floor plan map or directions generated would include location information concerning the location of the stores within the mall and the location of the products within the stores.

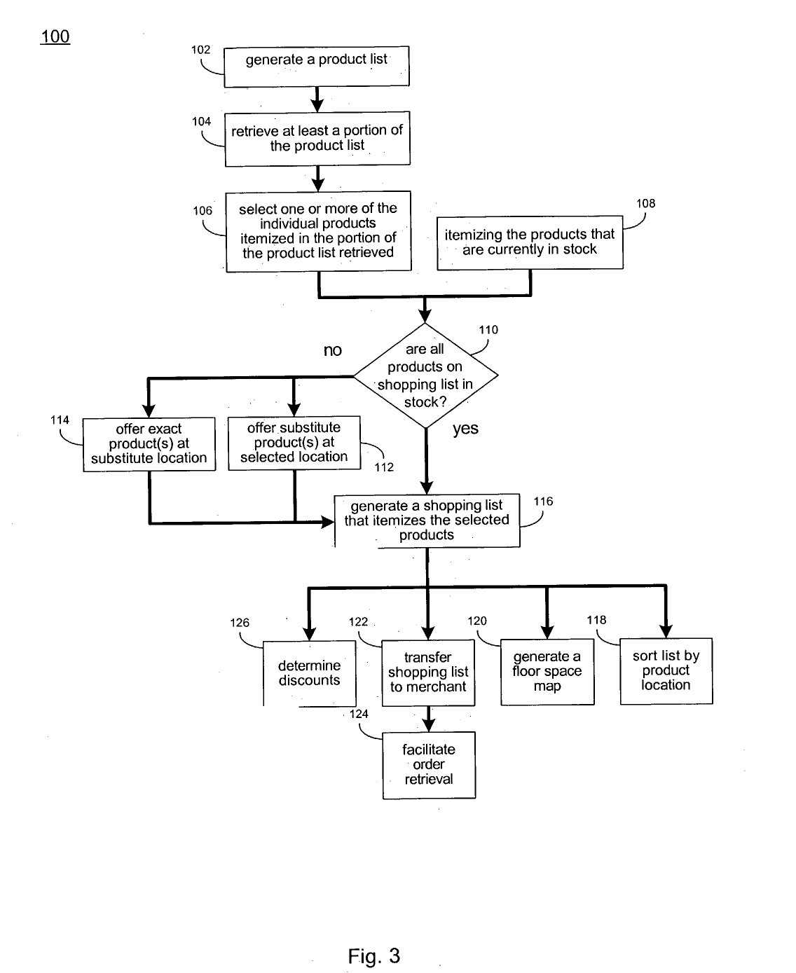

Referring to FIG. 3, an online list generation method 100 includes generating a product list that itemizes the products offered for sale by a merchant (102). A potential customer is allowed to retrieve at least a portion of the product list (104). This enables the potential customer to select one or more of the individual products itemized in the retrieved portion of the product list (106).

The products that are currently in stock at the merchant's place of business are itemized within an inventory database (108). A determination is made as to whether the individual products selected by the customer are in stock at the merchant's place of business (110). If a selected product is out of stock, the potential customer is offered a substitute product (112). If the merchant has multiple locations and the product, while not in stock at the location selected by the potential customer, is in stock at a different location, the potential customer is informed that the product is available at that different location (114).

When all selected products are in stock or substitutes have been selected, a shopping list that itemizes all selected products is generated (116). The individual products itemized in the shopping list may be sorted in accordance with their physical location within the merchant's place of business (118). In addition, a floor space map of the merchant's place of business may be generated to assist the potential customer in locating the products itemized in the shopping list (120). The shopping list may also be transferred to the merchant's place of business in association with a customer identifier that associates the shopping list with the potential customer (122). At the merchant's place of business, the individual products itemized in the shopping list may be retrieved so that they can be picked up by the potential customer (124). Finally, determination may be made as to whether any of the individual products itemized in the shopping list are being discounted (126).

The system described herein is not limited to the implementations described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Implementations of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Implementations of the system may also use integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

What is claimed is:

1. An online list generation process comprising:
a product database having a product list that itemizes products offered for sale by a merchant, and product location information for one or more of the products offered for sale by the merchant, wherein the product location information specifies the physical location of the product within the merchant's place of business.
a user interface that allows a potential customer to access the product database and retrieve at least a portion of the product list; and
a user selection process that enables the potential customer to select one or more of the individual products itemized in the retrieved portion of the product list to generate a shopping list that itemizes the individual products that the potential customer intends to pick up from the merchant's place of business, wherein the shopping list includes product location information for one or more of the itemized individual products.

2. The online list generation process of claim 1 further comprising an inventory database that itemizes the products that are currently in stock at the merchant's place of business.

3. The online list generation process of claim 2 further comprising an availability verification process, interfaced with the inventory database, for determining if the individual products itemized in the shopping list are in stock at the merchant's place of business.

4. The online list generation process of claim 3 further comprising a product substitution process for offering the potential customer a substitute product when the availability verification process determines that a product on the shopping list is out of stock.

5. The online list generation process of claim 3 wherein the merchant has multiple places of business, the inventory database is configured to itemize the products that are currently in stock at each of the merchant's places of business, and the potential customer selects the place of business at which the potential customer intends to shop, the online list generation process further comprising a location substitution process, responsive to the availability verification process determining that a product on the shopping list is out of stock at the place of business at which the potential customer intends to shop, for informing the potential customer that the out of stock product is available at an alternate place of business.

6. The online list generation process of claim 1 further comprising a location sorting process for sorting the individual products itemized in the shopping list in accordance with their physical location within the merchant's place of business.

7. The online list generation process of claim 1 further comprising a mapping process for generating a floor space map of the merchant's place of business, wherein the floor space map assists the potential customer in locating within the merchant's place of business the individual products itemized in the shopping list.

8. The online list generation process of claim 1 further comprising a list transfer process for transferring the shopping list to the merchant's place of business, wherein the shopping list includes a customer identifier for associating the shopping list with the potential customer.

9. The online list generation process of claim 8 further comprising an order preparation process, responsive to the list transfer process transferring the shopping list to the merchant's place of business, for facilitating the retrieval of the individual products itemized in the shopping list so that they can be picked up by the potential customer.

10. The online list generation process of claim 8 further comprising a discount determination process, responsive to the list transfer process transferring the shopping list to the merchant's place of business, for determining if any of the individual products itemized in the shopping list are being discounted.

11. The online list generation process of claim 1 wherein the product database includes product specification information for one or more of the products offered for sale by the merchant.

12. The online list generation process of claim 1 wherein the product database includes product review information for one or more of the products offered for sale by the merchant.

13. The online list generation process of claim 1 wherein the product database includes complimentary product information for one or more of the products offered for sale by the merchant.

14. An online list generation method comprising:
generating a product list that itemizes products offered for sale by a merchant;
allowing a potential customer to retrieve at least a portion of the product list;
enabling the potential customer to select one or more of the individual products itemized in the portion of the product list retrieved by the potential customer; and
generating a shopping list that itemizes the individual products that the potential customer intends to pick up from the merchant's place of business, wherein the shopping list includes product location information for one or more of the itemized individual products.

15. The online list generation method of claim 14 further comprising itemizing the products that are currently in stock at the merchant's place of business.

16. The online list generation method of claim 15 further comprising determining if the individual products itemized in the shopping list are in stock at the merchant's place of business.

17. The online list generation method of claim 16 further comprising offering the potential customer a substitute product upon determining that a product on the shopping list is out of stock.

18. The online list generation method of claim 16 wherein the merchant has multiple places of business, and the potential customer selects the place of business at which the potential customer intends to shop, the online list generation method further comprising informing the potential customer that a product on the shopping list is available at an alternate place of business if it is determined that the product on the shopping list is out of stock at the place of business at which the potential customer intends to shop.

19. The online list generation method of claim 14 further comprising sorting the individual products itemized in the shopping list in accordance with their physical location within the merchant's place of business.

20. The online list generation method of claim 14 further comprising generating a floor space map of the merchant's place of business, wherein the floor space map assists the potential customer in locating within the merchant's place of business the individual products itemized in the shopping list.

21. The online list generation method of claim 14 further comprising transferring the shopping list to the merchant's place of business, wherein the shopping list includes a customer identifier for associating the shopping list with the potential customer.

22. The online list generation method of claim 21 further comprising facilitating the retrieval of the individual products itemized in the shopping list so that they can be picked up by the potential customer.

23. The online list generation method of claim 21 further comprising determining if any of the individual products itemized in the shopping list are being discounted.

24. A computer program product residing on a computer readable medium having instructions stored thereon which, when executed by a processor, cause the processor to:
generate a product list that itemizes products offered for sale by a merchant;
allow a potential customer to retrieve at least a portion of the product list;
enable the potential customer to select one or more of the individual products itemized in the portion of the product list retrieved by the potential customer; and
generate a shopping list that itemizes the individual products that the potential customer intends to pick up from the merchant's place of business, wherein the shopping list includes product location information for one or more of the itemized individual products.

25. The computer program product of claim 24 further comprising instructions to itemize the products that are currently in stock at the merchant's place of business.

26. The computer program product of claim 25 further comprising instructions to determine if the individual products itemized in the shopping list are in stock at the merchant's place of business.

27. The computer program product of claim 26 further comprising instructions to offer the potential customer a substitute product if it is determined that a product on the shopping list is out of stock.

28. The computer program product of claim 26 wherein the merchant has multiple places of business, and the potential customer selects the place of business at which the potential customer intends to shop, the online list generation method further comprising instructions to inform the potential customer that a product on the shopping list is available at an alternate place of business if it is determined that the product on the shopping list is out of stock at the place of business at which the potential customer intends to shop.

29. The computer program product of claim 24 further comprising instructions to sort the individual products itemized in the shopping list in accordance with their physical location within the merchant's place of business.

30. The computer program product of claim 24 further comprising instructions to generate a floor space map of the merchant's place of business, wherein the floor space map assists the potential customer in locating within the merchant's place of business the individual products itemized in the shopping list.

31. The computer program product of claim 24 further comprising instructions to transfer the shopping list to the merchant's place of business, wherein the shopping list includes a customer identifier for associating the shopping list with the potential customer.

32. The computer program product of claim 31 further comprising instructions to facilitate the retrieval of the individual products itemized in the shopping list so that they can be picked up by the potential customer.

33. The computer program product of claim 31 further comprising instructions to determine if any of the individual products itemized in the shopping list are being discounted.

34. An online list generation process comprising:
a product database having a product list that itemizes products offered for sale by a merchant;
a user interface that allows a potential customer to access the product database and retrieve at least a portion of the product list; and
a user selection process that enables the potential customer to select one or more of the individual products itemized in the retrieved portion of the product list to generate a shopping list that itemizes the individual products that the potential customer intends to pick up from the merchant's place of business.

35. The online list generation process of claim 34 further comprising an inventory database that itemizes the products that are currently in stock at the merchant's place of business.

36. The online list generation process of claim 35 further comprising an availability verification process, interfaced with the inventory database, for determining if the individual products itemized in the shopping list are in stock at the merchant's place of business.

37. The online list generation process of claim 36 further comprising a product substitution process, responsive to the availability verification process determining that a product on the shopping list is out of stock, for offering the potential customer a substitute product.

38. The online list generation process of claim 36 wherein the merchant has multiple places of business, the inventory database is configured to itemize the products that are currently in stock at each of the merchant's places of business, and the potential customer selects the place of business at which they intend to shop, the online list generation process further comprising:
a location substitution process, responsive to the availability verification process determining that a product on the shopping list is out of stock at the place of business at which the potential customer intends to shop, for informing the potential customer that the out of stock product is available at an alternate place of business.

39. The online list generation process of claim 34 wherein the product database includes product location information for one or more of the products offered for sale by the merchant, wherein the product location information specifies the physical location of the product within the merchant's place of business.

40. The online list generation process of claim 39 further comprising a location sorting process for sorting the individual products itemized in the shopping list in accordance with their physical location within the merchant's place of business.

41. The online list generation process of claim 39 further comprising a mapping process for generating a floor space map of the merchant's place of business, wherein the floor space map assists the potential customer in locating the individual products, itemized in the shopping list, within the merchant's place of business.

42. The online list generation process of claim 34 further comprising a list transfer process for transferring the shopping list to the merchant's place of business, wherein the shopping list includes a customer identifier for associating the shopping list with the potential customer.

43. The online list generation process of claim 42 further comprising an order preparation process, responsive to the list transfer process transferring the shopping list to the merchant's place of business, for facilitating the retrieval of the individual products itemized in the shopping list so that they can be picked up by the potential customer.

44. The online list generation process of claim 42 further comprising a discount determination process, responsive to the list transfer process transferring the shopping list to the merchant's place of business, for determining if any of the individual products itemized in the shopping list are being discounted.

45. The online list generation process of claim 34 wherein the product database includes product specification information for one or more of the products offered for sale by the merchant.

46. The online list generation process of claim 34 wherein the product database includes product review information for one or more of the products offered for sale by the merchant.

47. The online list generation process of claim 34 wherein the product database includes complimentary product information for one or more of the products offered for sale by the merchant.

48. An online list generation method comprising:
generating a product list that itemizes products offered for sale by a merchant;
allowing a potential customer to retrieve at least a portion of the product list;
enabling the potential customer to select one or more of the individual products itemized in the portion of the product list retrieved by the potential customer; and
generating a shopping list that itemizes the individual products that the potential customer intends to pick up from the merchant's place of business.

49. The online list generation method of claim 48 further comprising itemizing the products that are currently in stock at the merchant's place of business.

50. The online list generation method of claim 49 further comprising determining if the individual products itemized in the shopping list are in stock at the merchant's place of business.

51. The online list generation method of claim 50 further comprising offering the potential customer a substitute product if it is determined that a product on the shopping list is out of stock.

52. The online list generation method of claim 50 wherein the merchant has multiple places of business, and the potential customer selects the place of business at which they intend to shop, the online list generation method further comprising:
informing the potential customer that a product on the shopping list is available at an alternate place of business if it is determined that the product on the shopping list is out of stock at the place of business at which the potential customer intends to shop.

53. The online list generation method of claim 48 further comprising sorting the individual products itemized in the shopping list in accordance with their physical location within the merchant's place of business.

54. The online list generation method of claim 48 further comprising generating a floor space map of the merchant's place of business, wherein the floor space map assists the potential customer in locating the individual products, itemized in the shopping list, within the merchant's place of business.

55. The online list generation method of claim 48 further comprising transferring the shopping list to the merchant's place of business, wherein the shopping list includes a customer identifier for associating the shopping list with the potential customer.

56. The online list generation method of claim 55 further comprising facilitating the retrieval of the individual products itemized in the shopping list so that they can be picked up by the potential customer.

57. The online list generation method of claim 55 further comprising determining if any of the individual products itemized in the shopping list are being discounted.

58. A computer program product residing on a computer readable medium having a plurality of instructions stored thereon which, when executed by the processor, cause that processor to:
generate a product list that itemizes products offered for sale by a merchant;
allow a potential customer to retrieve at least a portion of the product list;
enable the potential customer to select one or more of the individual products itemized in the portion of the product list retrieved by the potential customer; and
generate a shopping list that itemizes the individual products that the potential customer intends to pick up from the merchant's place of business.

59. The computer program product of claim 58 further comprising instructions to itemize the products that are currently in stock at the merchant's place of business.

60. The computer program product of claim 59 further comprising instructions to determine if the individual products itemized in the shopping list are in stock at the merchant's place of business.

61. The computer program product of claim 60 further comprising instructions to offer the potential customer a substitute product if it is determined that a product on the shopping list is out of stock.

62. The computer program product of claim 60 wherein the merchant has multiple places of business, and the potential customer selects the place of business at which they intend to shop, the online list generation method further comprising instructions to:
inform the potential customer that a product on the shopping list is available at an alternate place of business if it is determined that the product on the shopping list is out of stock at the place of business at which the potential customer intends to shop.

63. The computer program product of claim 58 further comprising instructions to sort the individual products itemized in the shopping list in accordance with their physical location within the merchant's place of business.

64. The computer program product of claim 58 further comprising instructions to generate a floor space map of the merchant's place of business, wherein the floor space map assists the potential customer in locating the individual products, itemized in the shopping list, within the merchant's place of business.

65. The computer program product of claim 58 further comprising instructions to transfer the shopping list to the merchant's place of business, wherein the shopping list includes a customer identifier for associating the shopping list with the potential customer.

66. The computer program product of claim 65 further comprising instructions to facilitate the retrieval of the individual products itemized in the shopping list so that they can be picked up by the potential customer.

67. The computer program product of claim 65 further comprising instructions to determine if any of the individual products itemized in the shopping list are being discounted.
